(19) United States
(12) Patent Application Publication
(10) Pub. No.: US 2017/0316516 A1
(43) Pub. Date: Nov. 2, 2017

(54) SYSTEMS AND METHODS FOR MANAGING A SOCIAL AUTONOMOUS TAXI SERVICE

(71) Applicant: GM GLOBAL TECHNOLOGY OPERATIONS LLC, Detroit, MI (US)

(72) Inventors: CLAUDIA V. GOLDMAN-SHENHAR, MEVASSERET ZION (IL); GILA KAMHI, ZICHRON YAAKOV (IL)

(73) Assignee: GM GLOBAL TECHNOLOGY OPERATIONS LLC, Detroit, MI (US)

(21) Appl. No.: 15/480,710

(22) Filed: Apr. 6, 2017

Related U.S. Application Data
(60) Provisional application No. 62/329,926, filed on Apr. 29, 2016.

(51) Int. Cl. G06Q 50/00; G05D 1/00; G06Q 30/02; G06Q 50/30

(52) U.S. Cl. CPC G06Q 50/01; G06Q 50/30; G05D 1/0088; G06Q 30/0265

(57) ABSTRACT

Methods and systems are provided for enhancing user's social experience of a trip in an autonomous vehicle. In one embodiment, a method includes: maintaining information associated with a user's social preferences in a data storage device; and selectively coordinating the trip and riders in the autonomous vehicle based on the information maintained in the data storage device.

### CROSS-REFERENCE TO RELATED APPLICATIONS

This application claims the benefit of U.S. provisional patent application No. 62/329,926, filed Apr. 29, 2016 which is hereby incorporated by reference in its entirety.

### TECHNICAL FIELD

The technical field generally relates to transportation systems, and more particularly relates to methods and systems for enhancing a user's social experience of autonomous vehicles of a transportation system.

### BACKGROUND

An autonomous vehicle is a vehicle that is capable of sensing its environment and navigating with little or no user input. An autonomous vehicle senses its environment using sensing devices such as radar, lidar, image sensors, etc. The autonomous vehicle system further uses information from global positioning systems (GPS) technology, navigation systems, and/or drive-by-wire systems to navigate the vehicle.

Application based transportation services are becoming increasingly popular. Conventional application based transportation services connect a user with a local driver who is available to take the user from point A to point B. The driver uses their own personal vehicle to transport the user. In some instances, it would be desirable to use autonomous vehicles instead of driver based vehicles for the transportation. It would be further desirable to enhancing a user's social experience while riding in an autonomous vehicle of a transportation system. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for enhancing user's social experience of a trip in an autonomous vehicle. In one embodiment, a method includes: maintaining information associated with a user's social preferences in a data storage device; and selectively coordinating the trip and riders in the autonomous vehicle based on the information maintained in the data storage device.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a social experience enhancement system for a transportation system in accordance with various embodiments;

FIG. 2 is an illustration of a user interface associated with the social experience enhancement system in accordance with various embodiments;

FIG. 3 is an illustration of a use case of the user interface associated with the social experience enhancement system in accordance with various embodiments; and

FIG. 4 is a flowchart that illustrates a social experience enhancement method that can be performed by the social experience enhancement system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of transportation control systems, and that the vehicle system described herein is merely one example embodiment of the invention.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

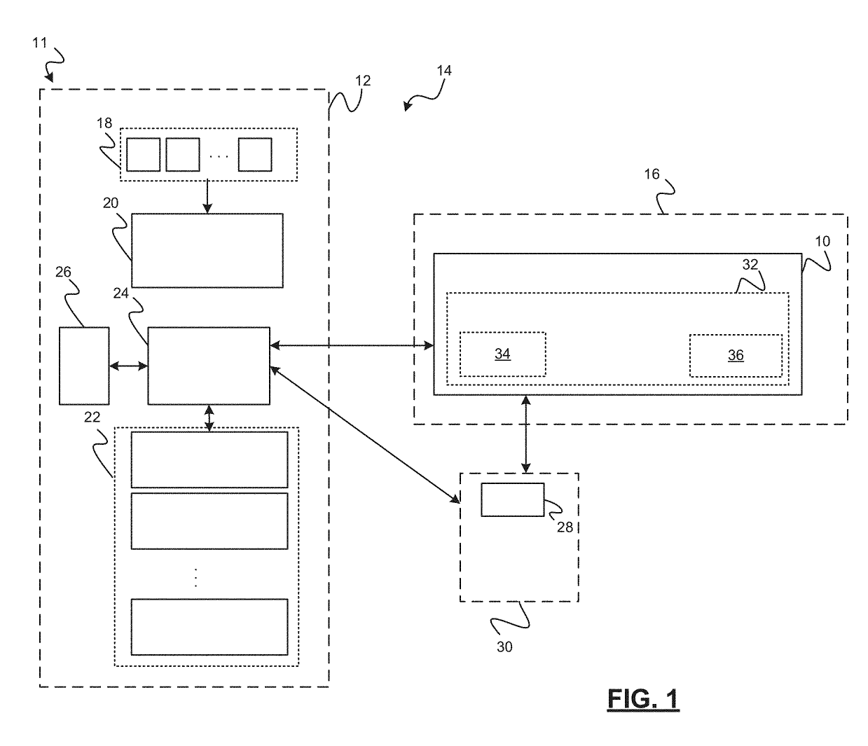

With initial reference to FIG. 1, a transportation system 10 for managing transportation provided by a fleet 11 of one or more vehicles 12 is shown to be associated with a social experience enhancement system 14 in accordance with various embodiments. The transportation system 10 can reside on a remote server 16 (as shown), on the autonomous vehicle 12 (not shown), or partially on the remote server 16 and partially on the autonomous vehicle 12. The fleet 11 of one more vehicles 12 can include autonomous vehicles, semi-autonomous vehicles, non-autonomous vehicles, or any combination thereof. For exemplary purposes, the disclosure will be discussed in the context of the fleet 11 including one or more autonomous vehicles. Although a single vehicle 12 is illustrated in FIG. 1, for clarity, it is understood that the fleet 11 can include more than a single vehicle 12.

Each of the autonomous vehicles 12 includes, among other features, one or more exterior sensors 18 that sense an element of an environment of the autonomous vehicle 12 and that generate sensor signals that are used to control one or more functions of the autonomous vehicle 12 to fully or partially drive the autonomous vehicle 12. For example, the sensor signals are used by one or more control systems 20 of the autonomous vehicle 12 to control the driving functions of the autonomous vehicle 12. When the autonomous vehicle 12 is an automobile, the control systems 20 can include, but are not limited to, a parking system, a vehicle cruise system, a lane keeping system, a lane change system, a vehicle steering system, etc. As can be appreciated, the control systems 20 described herein are merely exemplary, as any control system associated with providing full or partial autonomy can be included, in various embodiments. In addition, in various embodiments, the autonomous vehicle 12 can be controlled by commands, instructions, and/or inputs that are “self-generated” onboard the vehicle 12 itself. Alternatively or additionally, the autonomous vehicle 12 can be controlled by commands, instructions, and/or inputs that are generated by one or more components or systems external to the autonomous vehicle 12, including, without limitation: other autonomous vehicles; a backend server system; a control device or system located in an external operating environment associated with the autonomous vehicle 12; or the like. In certain embodiments, therefore, a given autonomous vehicle 12 can be controlled using vehicle-to-vehicle data communication, vehicle-to-infrastructure data communication, and/or infrastructure-to-vehicle communication.

In various embodiments, each of the autonomous vehicles 12 further includes one or more social ride enhancement systems 22. The social ride enhancement systems 22 are systems of the autonomous vehicle 12 that improve the user's social experience while riding in the autonomous vehicle 12. In various embodiments, the social ride enhancement systems 22 are associated with a particular social theme and offer in-vehicle services, goods, and/or atmosphere associated with that theme. For example, the social ride enhancement systems 22 can include, but are not limited to, a touring system that offers a scenic route to an attraction and attraction information (via a real guide or an automated guide) with interactions via virtual and augmented reality, a celebration system that offers celebration decor, foods, music, etc., a business interaction system that offers business transaction capabilities such as scanning, emailing, copying, etc., a meals system that offers themed meals, an education system that offers educational information and/or tours, a marriage system that offers a marriage service, or a dating system that offers music, food, entertainment. As can be appreciated, other social ride enhancement systems 22 can be included in various embodiments, as the disclosure is not limited to the present examples.

In various embodiments, the social ride enhancement systems 22 are integrated within the autonomous vehicle 12 and are activated by a control module 24. For example, upon receipt of a request to provide a particular social theme for a particular route or passenger, the control module 24 may activate and/or configure settings or options for the particular social ride enhancement system 22. The request may be initiated by a user through a user interface 26 of the autonomous vehicle 12 or a user interface 28 of a personal device 30 (e.g., a cell phone, a tablet, a personal computer, a wearable device, etc.) that communicates with the autonomous vehicle 12 or the transportation system 10. In another example, the request may be initiated by the remote transportation system 10 that communicates with the autonomous vehicle 12. In any of the embodiments, the requests can be initiated before or during the ride.

In various embodiments, when the request is initiated before the ride, the control module 24 automatically activates or configures settings of the social ride enhancement systems 22 based on a detection of the requesting user in proximity to the autonomous vehicle 12 or based upon a detection of the autonomous vehicle 12 reaching a particular location. In various embodiments, the control module 24 determines the presence of the requesting user based on a presence of the personal device 30 of the user in proximity to the autonomous vehicle 12.

In various other embodiments, one or more of social ride enhancement systems 22 are not integrated within the autonomous vehicle 12 rather, they are selectively supplied to the autonomous vehicle 12 based upon a request. For example, based upon a request to provide a particular social theme for a particular route or passenger, the transportation system 10 coordinates when and how to supply the autonomous vehicle 12 with the social ride enhancement system 22. For example, the transportation system 10 coordinates when and how based on a route, a current location, a drop-off location, and/or an occupancy of the autonomous vehicle 12.

In various embodiments, as further shown in FIG. 1, the transportation system 10 includes, among other features, a reservation system 32. The reservation system 32 coordinates trips and riders for autonomous vehicles 12 of the fleet 11 based on user preferences of social criteria. The reservation system 32 includes a data processing module 34 and a data storage device 36. The data storage device 36 stores information about users' social preferences. In various embodiments, the data storage device 36 can further store social ratings of the various users (e.g., as entered by users). The data processing module 34 collects and manages the data stored in the data storage device 36.

In various embodiments, the information stored in the data storage device 36 can be entered by a user via a user interface and collected by the data processing module 34. The user interface can be the same user interface 26, 28 for requesting a social ride enhancement system 22 or a different user interface (not shown) such as a web based interface, an interface for a stand-alone terminal, or other interface. For exemplary purposes, the embodiments will be discussed in the context of the user interfaces 26, 28.

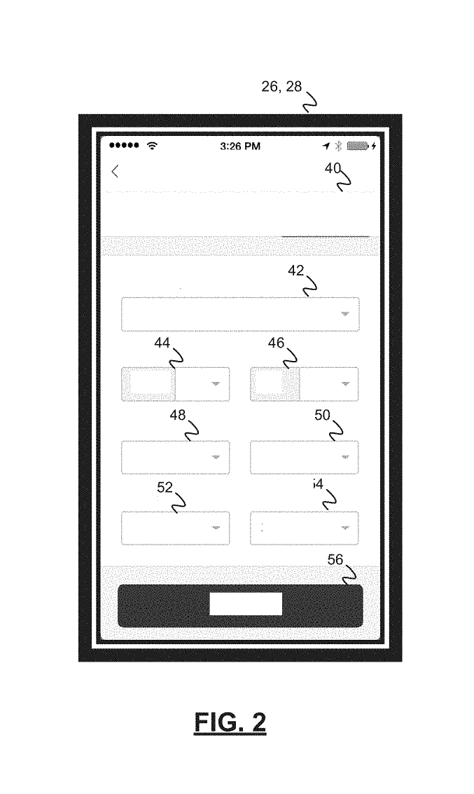

In one example, as shown in FIG. 2, the user interface 26, 28 can include one or more selection boxes, buttons, tabs, drop-down menus, text boxes, graphics, or other items that can be manipulated by a user in order to indicate social preferences. In the example shown in FIG. 2, the user interface 26, 28 includes a trip riders tab 40 that presents options for selecting social criteria desired for other riders. The options include, a social topic option 42 for selecting a social topic of a trip, an age minimum option 44 for selecting a minimum age of other riders, an age maximum option 46 for selecting a maximum age of other riders, a gender option 48 for selecting a gender of other riders, a vehicle climate option 50 for selecting a climate preference, a music option 52 for selecting a music preference, and a rating option 54 for selecting a rating of other users. The user interface 26, 28 further includes a search selection button, that when selected searches out other riders or vehicles having matching social preferences. Using the search selection button, a user can select one or more of the recommended other riders to share the ride or not accept any of the other riders. A user can change the selected preferences and search out new suggestions of riders.

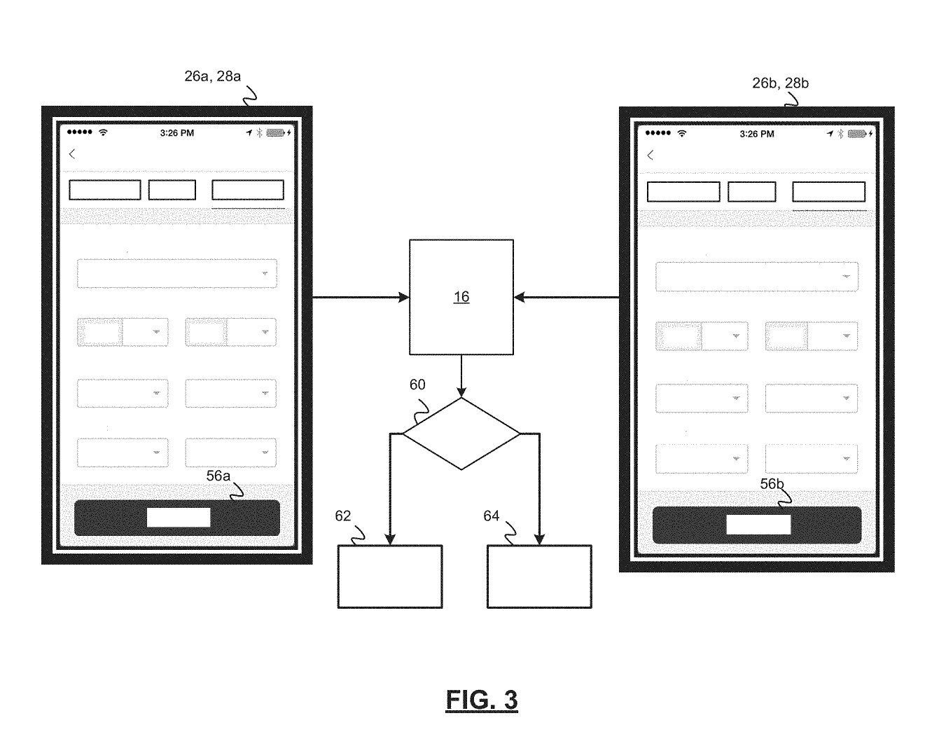

For example, as shown in FIG. 3, rider A, using user interface 26a, 28a, can enter social preferences using the one or more selection boxes, buttons, tabs, drop-down menus, text boxes, graphics, or other items. Upon selection of the search button 56a, by rider A, the entered preferences are submitted to the server 16. Similarly, rider B, using user interface 26b, 28b, can enter social preferences using the one or more selection boxes, buttons, tabs, drop-down menus, text boxes, graphics, or other times. Upon selection of the search button 56b, by rider B, the entered preferences are submitted to the server 16. The server 16 evaluates the stored preferences to determine if a match of preferences between riders exists. If a match exists, a shared ride is scheduled. If a match does not exist a solo ride is scheduled. As previously discussed, the user interfaces 26a, 26b, 28a, 28b are accessed through the autonomous vehicle 12 (e.g., by way of a display screen and one or more input devices) or through the personal device 30 (e.g., by way of a downloaded application, a browser and a web page, or by other means).

With reference back to FIG. 1, in various embodiments, the information stored in the data storage device 36 can be learned from preferences previously selected within an autonomous vehicle 12 by way of the control module 24 and communicated to the transportation system 10. In various embodiments, the information stored in the data storage device 36 can be learned from information stored on the personal device 30 and communicated to the transportation system 10. In various embodiments, the information stored in the data storage device 36 can be learned from patterns of social data generated from past social rides; pattern data can be generated by the control module 24 and/or the transportation system 10.

The transportation system 10 selects a particular autonomous vehicle 12 from the fleet 11 of one or more autonomous vehicles 12 for the transporting the user on a particular trip based on the information stored in the data storage device 24. For example, the transportation system 10 selects a particular vehicle that is equipped or that can be equipped with the requested social ride enhancement systems 22, and/or selects a particular vehicle scheduled to transport another occupant matching one or more of the social preferences entered by the user. In various embodiments, the transportation system selects particular riders that match one or more of the social preferences entered by the user. In various embodiments, when scheduling the trip, the transportation system 10 communicates the user's social preferences to the selected autonomous vehicle 12 such that the control system 20 can control any options or settings for the trip based thereon.

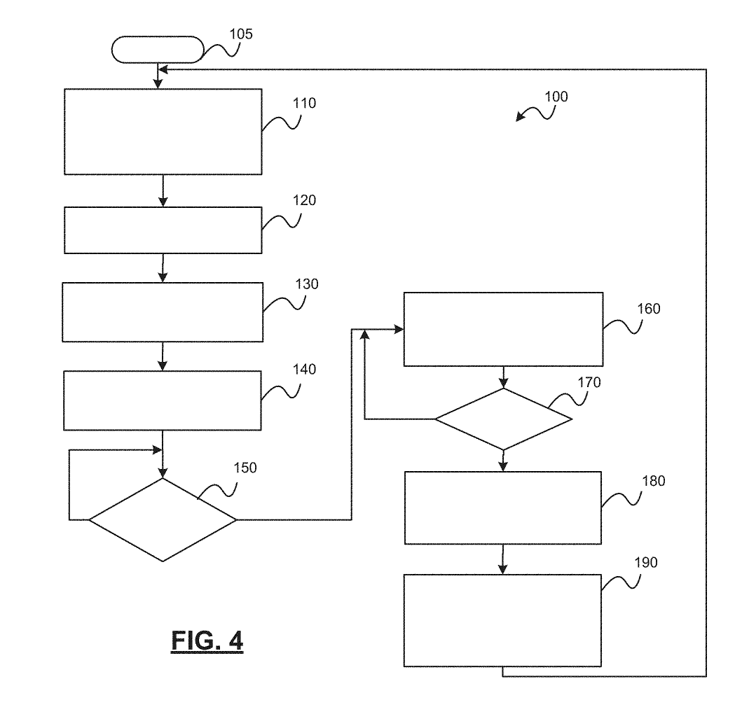

With reference now to FIG. 4, a flowchart illustrates a social experience enhancement method 100 in accordance with exemplary embodiments. The method 100 can be utilized in connection with the autonomous vehicle 12 and transportation system 10 of FIG. 4, in accordance with exemplary embodiments. As can be appreciated in light of the disclosure, the order of operation within the method is not limited to the sequential execution as illustrated in FIG. 4, but may be performed in one or more varying orders as applicable and in accordance with the present disclosure.

In various embodiments, the method may begin at 105. At 110, users' social preferences are obtained directly or indirectly from users, for example, as discussed above. The obtained information is stored in the data storage device 36 of the reservation system 32 at 120.

Thereafter, the stored information is evaluated by the transportation system 10 for example, as discussed above, to select an autonomous vehicle 12 or other riders for the trip at 130. The information is communicated by the transportation system 10 to the selected autonomous vehicle 12 at 140. Thereafter, the autonomous vehicle 12 is prepared for the social experience. For example, once the autonomous vehicle 12 detects the proximity of the user at 150, the control module 24 controls one or more of the social ride enhancement systems based on the information received at 160. Once the autonomous vehicle 12 detects that the ride is complete at 170, the control module 24 controls the social ride enhancement systems 22 based on default information or other information at 180. Optionally, the control module 24 communicates any user selected preferences to the transportation system 10 for updating the data storage device 36 at 190. Thereafter, the method may continue with step 110.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of enhancing user's social experience of a trip in an autonomous vehicle, comprising:
maintaining information associated with a user's social preferences in a data storage device; and
selectively coordinating the trip and riders in the autonomous vehicle based on the information maintained in the data storage device.

2. The method of claim 1, wherein the information includes at least one of social criteria desired for other riders, a social topic of a trip, a minimum age of other riders, a maximum age of other riders, a gender of other riders, a climate preference, a music preference, and a rating of other users.

3. The method of claim 1, wherein the selectively coordinating comprises determining a match of at least one preference between at least two users, and wherein the riders are the at least two users.

4. The method of claim 1, further comprising receiving the user's social preferences via a user interface of a personal device.

5. The method of claim 1, further comprising receiving the user's social preferences via a user interface of an autonomous vehicle.

6. The method of claim 1, further comprising selectively coordinating at least one of activation, options, and settings of a social ride enhancement system based on the information maintained in the data storage device.

7. The method of claim 6, further comprising automatically activating or configuring settings of the social ride enhancement system based on a detection of the requesting user in proximity to the autonomous vehicle.

8. The method of claim 6, further comprising automatically activating or configuring settings of the social ride enhancement system based on a detection of the autonomous vehicle reaching a particular location.

9. The method of claim 6, wherein the social ride enhancement system offers a good.

10. The method of claim 6, wherein the social ride enhancement system offers a service.

11. The method of claim 10, wherein the social ride enhancement system in an education system.

12. The method of claim 10, wherein the social ride enhancement system is a marriage system.

13. The method of claim 10, wherein the social ride enhancement system is a dating system.

14. The method of claim 10, wherein the social ride enhancement system includes a touring system.

15. The method of claim 6, wherein the social ride enhancement system offers an atmosphere of the vehicle.

16. The method of claim 15, wherein the social ride enhancement system is a celebration system.

17. The method of claim 6, wherein the social ride enhancement system offers a good.

18. The method of claim 17, wherein the social ride enhancement system is a business interaction system.

19. The method of claim 17, wherein the social ride enhancement system is a meals system.

20. An autonomous vehicle, comprising:
at least one social ride enhancement system; and
a control module that selectively controls the social ride enhancement system based on user preferences entered via a user interface of at least one of a vehicle and a personal device.
